(19) United States
(12) Patent Application Publication
(10) Pub. No.: US 2018/0305487 A1
(43) Pub. Date: Oct. 25, 2018

(54) PHOTOCURABLE COMPOSITION FOR PATTERN FORMATION AND PATTERNED BODY MANUFACTURED BY USING THE COMPOSITION

(71) Applicant: Samsung Display Co., Ltd., Yongin-si (KR)

(72) Inventors: Sanghee YU, Yongin-si (KR); Jaehong PARK, Yongin-si (KR); Jiyun PARK, Yongin-si (KR); Hyungguen YOON, Yongin-si (KR); Kyunghee LEE, Yongin-si (KR); Kyungseon TAK, Yongin-si (KR); Minhyuck KANG, Yongin-si (KR); Eunae KWAK, Yongin-si (KR); Hoilim KIM, Yongin-si (KR)

(21) Appl. No.: 15/870,145

(22) Filed: Jan. 12, 2018

(30) Foreign Application Priority Data
Apr. 25, 2017 (KR) 10-2017-0053238

(51) Int. Cl. C08F 220/68

(52) U.S. Cl. CPC C08F 220/68

(57) ABSTRACT

An exemplary embodiment of the application discloses a photocurable composition for pattern formation includes at least one multifunctional (meth)acrylate; at least one monofunctional (meth)acrylate; a release additive; and a photoinitiator, wherein the release additive includes a fluorine-based monomer and a silicon-based monomer.

### CROSS REFERENCE TO RELATED APPLICATION

This application claims priority from and the benefit of Korean Patent Application No. 10-2017-0053238, filed on Apr. 25, 2017, which is hereby incorporated by reference for all purposes as if fully set forth herein.

### BACKGROUND

### Field

Exemplary embodiments of the present invention relate to a photocurable composition for pattern formation and a patterned body manufactured by using the composition.

### Discussion of the Background

In recent years, in line with miniaturization of electronic products such as display devices, methods of forming fine patterns used in these devices have been studied from various perspectives.

Nanoimprint lithography is one method for forming fine patterns and involves etching a pattern on a substrate using an imprinting resin having a fine pattern as a mask. Nanoimprint lithography does not require process conditions such as high temperature or high pressure, and so it is suitable for mass production and may form fine patterns by a simple process using a polymer.

The above information disclosed in this Background section is only for enhancement of understanding of the background of the inventive concepts, and, therefore, it may contain information that does not form the prior art that is already known in this country to a person of ordinary skill in the art.

### SUMMARY

Exemplary embodiments of the present invention provide a photocurable composition for pattern formation and a patterned body manufactured by using the composition.

Additional features of the invention will be set forth in the description which follows, and in part will be apparent from the description, or may be learned by practice of the invention.

An exemplary embodiment of the present invention discloses a photocurable composition for pattern formation includes at least one multifunctional (meth)acrylate; at least one monofunctional (meth)acrylate; a release additive; and a photoinitiator, wherein the release additive includes a fluorine-based monomer represented by Formula 1 and a silicon-based monomer represented by Formula 2:

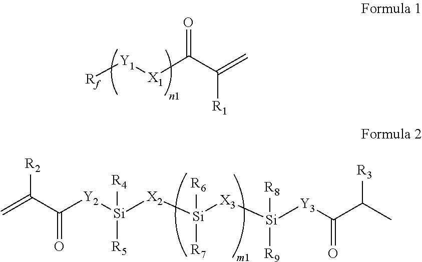

wherein, in Formulas 1 and 2, X₁, X₂, and X₃ are each independently a single bond, —O—, or —S—, Y₁, Y₂, and Y₃ are each independently selected from a single bond, —C(═O)—, —O—, a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group; and a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, a C₁-C₂₀ alkoxy group, a C₃-C₁₀ cycloalkyl group, a C₃-C₁₀ cycloalkenyl group, a C₂-C₁₀ heterocycloalkyl group, a C₂-C₁₀ heterocycloalkenyl group, a C₆-C₂₀ aryl group, and a C₂-C₂₀ heteroaryl group, R_{f} is a C₁-C₃₀ fluoroalkyl group, R₁, R₂, R₃, R₄, R₅, R₆, R₇, R₈, and R₉ are each independently selected from hydrogen, deuterium, a C₁-C₂₀ alkyl group, a C₂-C₂₀ alkenyl group, a C₂-C₂₀ alkynyl group, and a C₁-C₂₀ alkoxy group; and a C₁-C₂₀ alkyl group, a C₂-C₂₀ alkenyl group, a C₂-C₂₀ alkynyl group, and a C₁-C₂₀ alkoxy group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group, n1 is an integer selected from 1 to 10, and m1 is an integer selected from 1 to 10.

According to one or more exemplary embodiments, a patterned body is manufactured by using the photocurable composition for pattern formation.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view illustrating a nanoimprint lithography process using a patterned body according to an exemplary embodiment.

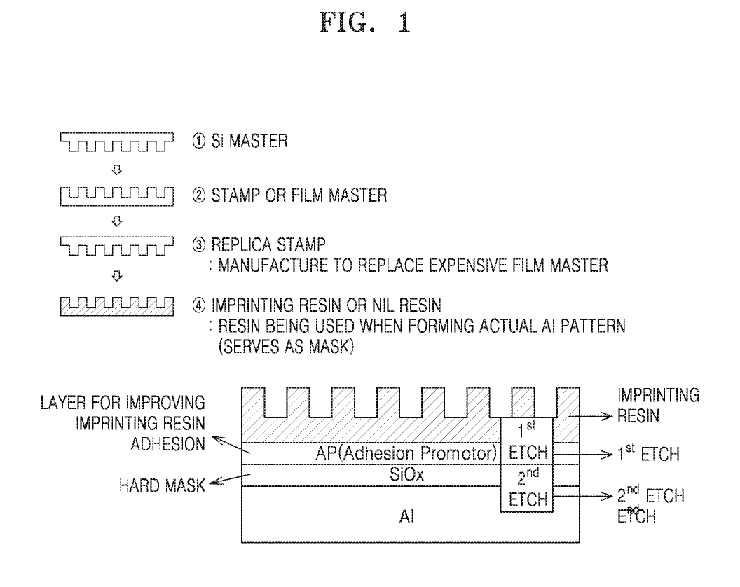

FIG. 2 shows the results of a releasability test performed on the patterned body according to an exemplary embodiment and a patterned body prepared by using a comparative composition.

FIG. 3 shows the results of a durability test performed on the patterned body according to an exemplary embodiment and the patterned body prepared by using a comparative composition.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

Unless otherwise specified, the illustrated exemplary embodiments are to be understood as providing exemplary features of varying detail of various exemplary embodiments. Therefore, unless otherwise specified, the features, components, modules, layers, films, panels, regions, and/or aspects of the various illustrations may be otherwise combined, separated, interchanged, and/or rearranged without departing from the disclosed exemplary embodiments. Further, in the accompanying figures, the size and relative sizes of layers, films, panels, regions, etc., may be exaggerated for clarity and descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. Further, the x-axis, the y-axis, and the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

According to an exemplary embodiment, a photocurable composition for pattern formation includes at least one multifunctional (meth)acrylate; at least one monofunctional (meth)acrylate; a release additive; and a photoinitiator.

In the photocurable composition for pattern formation, according to an exemplary embodiment, an amount of the at least one multifunctional (meth)acrylate may be in a range of about 20 parts to about 50 parts by weight, an amount of the at least one monofunctional (meth)acrylate may be in a range of about 40 parts to about 70 parts by weight, an amount of the release additive may be in a range of about 0.1 parts to about 10 parts by weight, and an amount of the photoinitiator may be in a range of about 0.1 parts to about 10 parts by weight.

In some exemplary embodiments, an amount of the release additive may be in a range of about 0.5 parts to about 5 parts by weight. When the amount of the release additive is within this range, a releasability and durability of the photocurable composition for pattern formation may improve, and a fine pattern, for example, a pattern having a pattern line width (CD) of 50 nm or less, may be formed.

Also, when the photocurable composition for pattern formation includes the at least one multifunctional (meth)acrylate at an amount in a range of about 20 parts to about 50 parts by weight, or, more preferably, about 30 parts to about 40 parts by weight, rigidity of the composition after curing may increase, and a releasability of the composition may improve.

When the photocurable composition for pattern formation includes the at least one monofunctional (meth)acrylate at an amount in a range of about 40 parts to about 70 parts by weight, or, more preferably, about 50 parts to about 60 parts by weight, viscosity of the composition may be controlled, and a releasability of a desired level may be secured in the final cured product.

According to an exemplary embodiment, the release additive includes a fluorine-based monomer represented by Formula 1 and a silicon-based monomer represented by Formula 2:

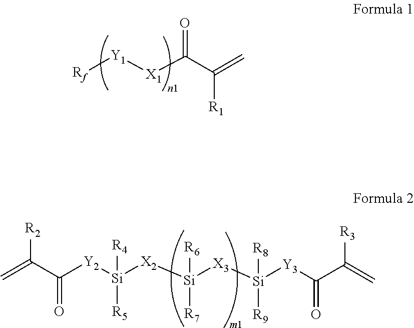

In Formulas 1 and 2, X₁, X₂, and X₃ may each independently be a single bond, —O—, or —S—.

In Formulas 1 and 2, Y₁, Y₂, and Y₃ may each independently be selected from
a single bond, —C(═O)—, —O—, a C₁-C₂₀ alkylene group, a C₃-C₁₀ cycloalkylene group, a C₃-C₁₀ cycloalkenylene group, C₂-C₁₀ heterocycloalkylene group, a C₂-C₁₀ heterocycloalkenylene group, a C₆-C₂₀ arylene group, and a C₂-C₂₀ heteroarylene group; and
a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, a C₁-C₂₀ alkoxy group, a C₃-C₁₀ cycloalkyl group, a C₃-C₁₀ cycloalkenyl group, a C₂-C₁₀ heterocycloalkyl group, a C₂-C₁₀ heterocycloalkenyl group, a C₆-C₂₀ aryl group, and a C₂-C₂₀ heteroaryl group.

In one exemplary embodiment, Y₁, Y₂, and Y₃ may each independently be selected from a single bond, —C(═O)—, —O—, and a C₁-C₂₀ alkylene group; and a C₁-C₂₀ alkylene group substituted with at least one selected from a deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group, but embodiments are not limited thereto.

In Formula 1, R_{f} may be a C₁-C₃₀ fluoroalkyl group.

As generally referred to in the art, the term “fluoroalkyl group” denotes an alkyl group in which at least one hydrogen of the alkyl group is substituted by —F.

In one exemplary embodiment, in Formula 1, R_{f} may be a C₁-C₃₀ perfluoroalkyl group.

As generally referred to in the art, the term “perfluoroalkyl group” denotes an alkyl group in which each hydrogen of the alkyl group is substituted by —F, that is, the alkyl group is saturated with fluorine atoms.

In one exemplary embodiment, in Formula 1, a structure R_{f}—(Y₁—X₁ₙ₁—* may include, for example, a structure saturated with fluorine atoms, such as a perfluorine polyether (PFPE) group, but embodiments are not limited thereto.

In another exemplary embodiment, in Formula 1, a part of the structure Rᵣ(Y₁—X₁ₙ₁—* may be PFPE. For example, X₁ may be PFPE, or Y₁ may be PFPE.

In Formulas 1 and 2, R₁, R₂, R₃, R₄, R₅, R₆, R₇, R₈, and R₉ may each independently be selected from hydrogen, deuterium, a C₁-C₂₀ alkyl group, a C₂-C₂₀ alkenyl group, a C₂-C₂₀ alkynyl group, and a C₁-C₂₀ alkoxy group; and a C₁-C₂₀ alkyl group, a C₂-C₂₀ alkenyl group, a C₂-C₂₀ alkynyl group, and a C₁-C₂₀ alkoxy group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group.

In one exemplary embodiment, R₁, R₂, R₃, R₄, R₅, R₆, R₇, R₈, and R₉ may each independently be selected from hydrogen, deuterium, and a C₁-C₂₀ alkyl group; and a C₁-C₂₀ alkyl group substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group, but exemplary embodiments are not limited thereto.

In another exemplary embodiment, R₁, R₂, R₃, R₄, R₅, R₆, R₇, R₈, and R₉ may be each independently selected from hydrogen, deuterium, a methyl group, an ethyl group, an n-propyl group, an iso-propyl group, an n-butyl group, an iso-butyl group, and a tert-butyl group.

In another exemplary embodiment, R₁, R₂, R₃, R₄, R₅, R₆, R₇, R₈, and R₉ may each independently be hydrogen or a methyl group.

In Formula 1, n1 is an integer selected from 0 to 10.

In an exemplary embodiment, n1 may be 0, 1, 2, 3, 4, 5, or 6.

In another exemplary embodiment, n1 may be 0, 1, 2, or 3.

In Formula 2, m1 may be an integer selected from 0 to 10.

In an exemplary embodiment, m1 may be 0, 1, 2, 3, 4, 5, or 6.

In another exemplary embodiment, m1 may be 0, 1, 2, or 3.

In some exemplary embodiments, the fluorine-based monomer represented by Formula 1 may be represented by Formula 1-1:

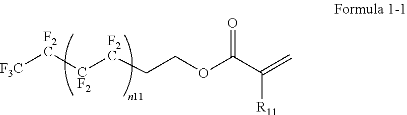

In Formula 1-1, R₁₁ may be selected from hydrogen, deuterium, and a C₁-C₂₀ alkyl group; and a C₁-C₂₀ alkyl group substituted with at least one selected from deuterium, a C₁-C₂₀ alkyl group, and a C₁-C₂₀ alkoxy group.

In an exemplary embodiment, R₁₁ may be selected from hydrogen, deuterium, and a C₁-C₂₀ alkyl group; and a C₁-C₂₀ alkyl group substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group, but exemplary embodiments are not limited thereto.

In another exemplary embodiment, R₁₁ may be selected from hydrogen, deuterium, a methyl group, an ethyl group, an n-propyl group, an iso-propyl group, an n-butyl group, an iso-butyl group, and a tert-butyl group.

In another exemplary embodiment, R₁₁ may be hydrogen or a methyl group.

In Formula 1-1, n11 is an integer selected from 0 to 10.

In an exemplary embodiment, n11 may be 0, 1, 2, 3, 4, 5, or 6.

In another exemplary embodiment, n11 may be 0, 1, 2, or 3.

In an exemplary embodiment, the silicon-based monomer represented by Formula 2 may be represented by Formula 2-1:

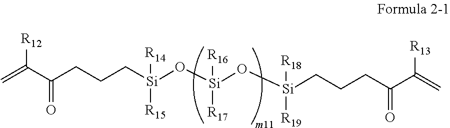

In Formula 2-1, R₁₂, R₁₃, R₁₄, R₁₅, R₁₆, R₁₇, R₁₈, and R₁₉ may be each independently selected from hydrogen, deuterium, and a C₁-C₂₀ alkyl group; and a C₁-C₂₀ alkyl group substituted with at least one selected from deuterium, a C₁-C₂₀ alkyl group, and a C₁-C₂₀ alkoxy group.

In an exemplary embodiment, R₁₂, R₁₃, R₁₄, R₁₅, R₁₆, R₁₇, R₁₈, and R₁₉ may each independently be selected from hydrogen, deuterium, and a C₁-C₂₀ alkyl group; and a C₁-C₂₀ alkyl group substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group, but exemplary embodiments are not limited thereto.

In another exemplary embodiment, R₁₂, R₁₃, R₁₄, R₁₅, R₁₆, R₁₇, R₁₈, and R₁₉ may each independently be selected from hydrogen, deuterium, a methyl group, an ethyl group, an n-propyl group, an iso-propyl group, an n-butyl group, an iso-butyl group, and a tert-butyl group.

In another exemplary embodiment, R₁₂, R₁₃, R₁₄, R₁₅, R₁₆, R₁₇, R₁₈, and R₁₉ may each independently be hydrogen or a methyl group.

In Formula 2-1, m11 is an integer selected from 0 to 10.

In an exemplary embodiment, m11 may be 0, 1, 2, 3, 4, 5, or 6.

In another exemplary embodiment, m11 may be 0, 1, 2, or 3.

In an exemplary embodiment, the release additive may include difunctional (meth)acrylate.

In an exemplary embodiment, the difunctional (meth)acrylate may include ethyleneglycol di(meth)acrylate, diethyleneglycol di(meth)acrylate, triethyleneglycol di(meth)acrylate, propyleneglycol di(meth)acrylate, dipropyleneglycol di(meth)acrylate, neopentylgylcol di(meth)acrylate, 1,4-butanediol di(meth)acrylate, 1,6-hexanediol di(meth)acrylate, bisphenol A di(meth)acrylate, pentaerythritol di(meth)acrylate, dipentaerythritol di(meth)acrylate, or a combination thereof.

In another exemplary embodiment, the difunctional (meth)acrylate monomer may include ethyleneglycol di(meth)acrylate, diethyleneglycol di(meth)acrylate, triethyleneglycol di(meth)acrylate, propyleneglycol di(meth)acrylate, dipropyleneglycol di(meth)acrylate, or a combination thereof.

In an exemplary embodiment, an amount of the difunctional (meth)acrylate may be in a range of about 10 parts to about 40 parts by weight based on 100 parts by weight of the photocurable composition for pattern formation. For example, an amount of the difunctional (meth)acrylate may be in a range of about 20 parts to about 30 parts by weight based on 100 parts by weight of the photocurable composition for pattern formation.

The difunctional (meth)acrylate maintains viscosity of the whole composition as well as the monofunctional (meth)acrylate does, and the amount of the difunctional (meth)acrylate may be controlled to control a degree of cross-linking.

In an exemplary embodiment, the release additive may include other polymeric monomers that provide a releasability in addition to the fluorine-based monomer represented by Formula 1 and the silicon-based monomer represented by Formula 2. However, since the release additive needs to have sufficient compatibility with (meth)acrylate, a urethane acrylate-based monomer may not be suitable as an example of the photocurable composition for pattern formation.

In an exemplary embodiment, the at least one multifunctional (meth)acrylate may be selected from pentaerythritol tri(meth)acrylate, pentaerythritol tetra(meth)acrylate, pentaerythritol hexa(meth)acrylate, dipentaerythritol tri(meth)acrylate, dipentaerythritol penta(meth)acrylate, dipentaerythritol hexa(meth)acrylate, bisphenolA epoxy (meth)acrylate, trimethylolpropane tri(meth)acrylate, tris(meth)acryloyloxyethyl phosphate, novolakepoxy (meth)acrylate, EO modified trimethylolpropane tri(meth)acrylate, ethylene oxide (EO) modified pentaerythritol tetra(meth)acrylate, epichlorohydrin (ECH) modified glyceroltri(meth)acrylate, EO modified glycerol tri(meth)acrylate, phosphine oxide (PO) modified glycerol tri(meth)acrylate, pentaerythritoltriacrylate, EO modified phosphoric acidtriacrylate, trimethylolpropanetri(meth)acrylate, caprolactone modified trimethylolpropanetri(meth)acrylate, EO modified trimethylolpropanetri(meth)acrylate, PO modified trimethylolpropanetri(meth)acrylate, tris(acryloxyethyl)isocyanurate, dipentaerythritolhexa(meth)acrylate, caprolactone modified dipentaerythritolhexa(meth)acrylate, dipentaerythritol hydroxypenta(meth)acrylate, alkyl modified dipentaerythritolpenta(meth)acrylate, dipentaerythritol poly(meth)acrylate, alkyl modified dipentaerythritoltri(meth)acrylate, and a combination thereof.

In another exemplary embodiment, the at least one multifunctional (meth)acrylate may be selected from pentaerythritol tri(meth)acrylate, pentaerythritol tetra(meth)acrylate, pentaerythritol hexa(meth)acrylate, dipentaerythritol tri(meth)acrylate, dipentaerythritol penta(meth)acrylate, dipentaerythritol hexa(meth)acrylate, trimethylolpropane tri(meth)acrylate, tris(meth)acryloyloxyethyl phosphate, EO modified trimethylolpropane tri(meth)acrylate, EO modified pentaerythritol tetra(meth)acrylate, and a combination thereof.

In an exemplary embodiment, at least one example of the at least one multifunctional (meth)acrylate may include a multifunctional (meth)acrylate including at least 4 functional groups.

When the multifunctional (meth)acrylate including at least 4 functional groups, such as penta(meth)acrylate or hexa(meth)acrylate, is used, a degree of curing of the photocurable composition for pattern formation may increase, and thus its durability may improve, and deterioration of releasing characteristics of a surface of the patterned body may be suppressed due to monofunctional (meth)acrylate or difunctional (meth)acrylate that is used to adjust viscosity to a desired level.

In one exemplary embodiment, the multifunctional (meth)acrylate including at least 4 functional groups may be selected from pentaerythritol tetra(meth)acrylate, dipentaerythritol hexa(meth)acrylate, ditrimethylolpropane tetra(meth)acrylate, dipentaerythritol penta(meth)acrylate, and a combination thereof, but exemplary embodiments are not limited thereto.

In an exemplary embodiment, at least one example of the at least one multifunctional (meth)acrylate may be EO-modified multifunctional (meth)acrylate.

For example, the at least one multifunctional (meth)acrylate may include the multifunctional (meth)acrylate including at least 4 functional groups, and may further include EO-modified multifunctional (meth)acrylate, but embodiments are not limited thereto.

For example, the at least one multifunctional (meth)acrylate may include the multifunctional (meth)acrylate including at least 4 functional groups, wherein the multifunctional (meth)acrylate including at least 4 functional groups may be EO-modified multifunctional (meth)acrylate, or the at least one multifunctional (meth)acrylate may further include EO-modified multifunctional (meth)acrylate that is different from the multifunctional (meth)acrylate including at least 4 functional groups.

For example, the at least one multifunctional (meth)acrylate may include EO-modified multifunctional (meth)acrylate, and the EO-modified multifunctional (meth)acrylate may include at least 4 functional groups or less than 4 functional groups.

In an exemplary embodiment, the EO-modified multifunctional (meth)acrylate may be selected from EO-modified trimethylolpropane tri(meth)acrylate, EO-modified pentaerythritol tetra(meth)acrylate, and a combination thereof, but exemplary embodiments are not limited thereto.

In one exemplary embodiment, the at least one multifunctional (meth)acrylate may be selected from EO-modified trimethylolpropane tri(meth)acrylate, EO-modified pentaerythritol tetra(meth)acrylate, pentaerythritol tri(meth)acrylate, ditrimethylolpropane tetra(meth)acrylate, dipentaerythritol hexa(meth)acrylate, dipentaerythritol penta(meth)acrylate, and a combination thereof, but exemplary embodiments are not limited thereto.

In an exemplary embodiment, the at least one monofunctional (meth)acrylate may be selected from methyl (meth)acrylate, ethyl (meth)acrylate, n-propyl (meth)acrylate, isopropyl (meth)acrylate, n-butyl (meth)acrylate, isoamyl (meth)acrylate, isobutyl (meth)acrylate, isooctyl (meth)acrylate, sec-butyl (meth)acrylate, t-butyl (meth)acrylate, n-pentyl (meth)acrylate, 3-methylbutyl (meth)acrylate, n-hexyl (meth)acrylate, 2-ethyl-n-hexyl (meth)acrylate, n-octyl (meth)acrylate, cyclohexyl (meth)acrylate, isobornyl (meth)acrylate, dicyclopentanyl(meth)acrylate, dicyclopentanyloxyethyl (meth)acrylate, isomyristyl (meth)acrylate, lauryl (meth)acrylate, methoxydipropyleneglycol (meth)acrylate, methoxytripropyleneglycol (meth)acrylate, benzyl (meth)acrylate, 2-hydroxyethyl (meth)acrylate, 2-hydroxypropyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 4-hydroxycyclohexyl (meth)acrylate, neopentylglycol mono(meth)acrylate, 3-chloro-2-hydroxypropyl (meth)acrylate, 1,1-dimethyl-3-oxobutyl (meth)acrylate, 2-acetoacetoxyethyl (meth)acrylate, 2-methoxyethyl (meth)acrylate, 2-ethoxyethyl (meth)acrylate, neopentylglycol mono(meth)acrylate, ethyleneglycol monomethylether (meth)acrylate, glycerin mono(meth)acrylate, 2-acryloyloxyethyl phthalate, 2-acryloyloxy 2-hydroxyethyl phthalate, 2-acryloyloxyethyl hexahydrophthalate, 2-acryloyloxy propylphthalate, neopentylglycolbenzoate (meth)acrylate, nonylpenoxypolyethyleneglycol (meth)acrylate, nonylpenoxypolypropyleneglycol (meth)acrylate, para-cumylphenoxyethyleneglycol (meth)acrylate, ECH modified phenoxy acrylate, phenoxyethyl (meth)acrylate, phenoxydiethyleneglycol (meth)acrylate, phenoxyhexaethyleneglycol (meth)acrylate, phenoxytetraethyleneglycol (meth)acrylate, polyethyleneglycol (meth)acrylate, polyethyleneglycol-polypropyleneglycol (meth)acrylate, polypropyleneglycol (meth)acrylate, stearyl (meth)acrylate, EO-modified cresol (meth)acrylate, dipropyleneglycol (meth)acrylate, ethoxylated phenyl(meth)acrylate, EO-modified succinic acid (meth)acrylate, tert-butyl (meth)acrylate, tribromophenyl (meth)acrylate, EO-modified tribromophenyl (meth)acrylate, tridodecyl (meth)acrylate, and a combination thereof.

In another exemplary embodiment the at least one monofunctional (meth)acrylate may include at least one structure selected from
a C₅-C₆₀ carbocyclic group and a C₁-C₆₀ heterocyclic group; and
a C₅-C₆₀ carbocyclic group and a C₁-C₆₀ heterocyclic group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, a C₁-C₂₀ alkoxy group, a C₃-C₁₀ cycloalkyl group, a C₃-C₁₀ cycloalkenyl group, a C₂-C₁₀ heterocycloalkyl group, a C₂-C₁₀ heterocycloalkenyl group, a C₆-C₂₀ aryl group, and a C₂-C₂₀ heteroaryl group.

In another exemplary embodiment, the at least one monofunctional (meth)acrylate may be selected from benzyl (meth)acrylate, trimethylcyclohexyl (meth)acrylate, cyclic trimethylolpropane form(meth)acrylate, and a combination thereof.

In an exemplary embodiment, the photocurable composition for pattern formation may further include at least one difunctional (meth)acrylate.

In an exemplary embodiment, the at least one difunctional (meth)acrylate may be selected from ethylene glycol di(meth)acrylate, diethylene glycol di(meth)acrylate, triethylene glycol di(meth)acrylate, propylene glycol di(meth)acrylate, neopentyl glycol di(meth)acrylate, 1,4-butanediol di(meth)acrylate, 1,6-hexanediol di(meth)acrylate, bisphenol A di(meth)acrylate, pentaerythritol di(meth)acrylate, dipentaerythritol di(meth)acrylate, and a combination thereof.

The photoinitiator may be used to promote polymerization of a monomer and to improve a curing rate, and thus any known photoinitiator may be used. For example, the photoinitiator may be 1-hydroxy-cyclohexyl-phenyl-ketone, 2-hydroxy-2-methyl-1-phenyl-1-propanone, 2-hydroxy-1-[4-2-hydroxyethoxy)phenyl]-2-methyl-1-propanone, methylbenzoylformate, oxy-phenyl-acetic acid-2-[2-oxo-2-phenyl-acetoxy-ethoxy]-ethyl ester, oxy-phenyl-acetic acid-2-[2-hydroxy-ethoxy]-ethyl ester, alpha-dimethoxy-alpha-phenylacetophenone, 2-benzyl-2-(dimethylamino)-1-[4-4-morpholinylphenyl]-1-butanone, 2-methyl-1-[4-(methylthio)phenyl]-2-4-morpholinyl-1-propanone, diphenyl(2,4,6-trimethylbenzoyl)-phosphine oxide, phenyl bis 2,4,6-trimethyl benzoyl) phosphine oxide, or a combination thereof.

In an exemplary embodiment, the photoinitiator may be selected from a phenyl ketone-based compound, a phosphine oxide-based compound, and a combination thereof. For example, the photoinitiator may be 1-hydroxycyclohexyl phenyl ketone, phenyl bis 2,4,6-trimethylbenzoyl phosphine oxide, or a combination thereof.

In another exemplary embodiment, the photoinitiator may include a phenyl ketone-based compound and a phosphine oxide-based compound, and a weight ratio of the phenyl ketone-based compound and the phosphine oxide-based compound may be in a range of about 0.8:1 to about 1:0.8, but exemplary embodiments are not limited thereto.

In an exemplary embodiment, the photocurable composition for pattern formation may further include an aryl phosphine-based compound. The aryl phosphine-based compound suppresses inhibition of polymerization caused by oxygen, and thus may improve polymerization stability of the photocurable composition.

In another exemplary embodiment, the aryl phosphine-based compound may be triphenyl phosphine or triphenyl phosphite, but embodiments are not limited thereto.

An amount of the aryl phosphine-based compound may be in a range of about 0.1 parts to about 10 parts by weight, but embodiments are not limited thereto.

According to another embodiment, a patterned body manufactured by using the photocurable composition for pattern formation is provided.

In an exemplary embodiment, the patterned body may include a unit represented by Formula 3:

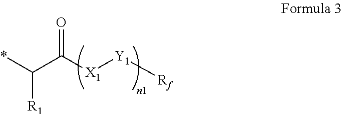

In Formula 3, X₁ may be a single bond, —O—, or —S—.

In Formula 3, Y₁ may be selected from a single bond, —C(═O)—, —O—, a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group; and a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, a C₁-C₂₀ alkoxy group, a C₃-C₁₀ cycloalkyl group, a C₃-C₁₀ cycloalkenyl group, a C₂-C₁₀ heterocycloalkyl group, a C₂-C₁₀ heterocycloalkenyl group, a C₆-C₂₀ aryl group, and a C₂-C₂₀ heteroaryl group.

In Formula 3, R_{f} may be a C₁-C₃₀ fluoroalkyl group.

In Formula 3, R₁ may be selected from hydrogen, deuterium, a C₁-C₂₀ alkyl group, a C₂-C₂₀ alkenyl group, a C₂-C₂₀ alkynyl group, and a C₁-C₂₀ alkoxy group; and a C₁-C₂₀ alkyl group, a C₂-C₂₀ alkenyl group, a C₂-C₂₀ alkynyl group, and a C₁-C₂₀ alkoxy group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group.

In Formula 3, n1 may be an integer selected from 0 to 10.

* is a binding site to a neighboring atom.

In an exemplary embodiment, X₁, Y₁, R_{f}, R₁, and n1 may be the same as defined in relation to Formula 1.

In an exemplary embodiment, the patterned body may include a unit represented by Formula 4:

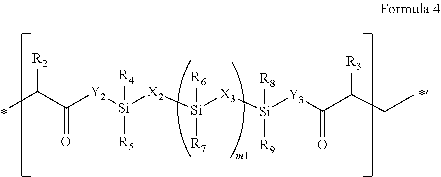

In Formula 4, X₂ and X₃ may each independently be a single bond, —O—, or —S—.

In Formula 4, Y₂ and Y₃ may each independently be selected from a single bond, —C(═O)—, —O—, a C₁-C₂₀ alkylene group, a C₃-C₁₀ cycloalkylene group, a C₃-C₁₀ cycloalkenylene group, C₂-C₁₀ heterocycloalkylene group, a C₂-C₁₀ heterocycloalkenylene group, a C₆-C₂₀ arylene group, and a C₂-C₂₀ heteroarylene group; and a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, a C₁-C₂₀ alkoxy group, a C₃-C₁₀ cycloalkyl group, a C₃-C₁₀ cycloalkenyl group, a C₂-C₁₀ heterocycloalkyl group, a C₂-C₁₀ heterocycloalkenyl group, a C₆-C₂₀ aryl group, and a C₂-C₂₀ heteroaryl group.

In Formula 4, R₂, R₃, R₄, R₅, R₆, R₇, R₈, and R₉ may each independently be selected from hydrogen, deuterium, a C₁-C₂₀ alkyl group, a C₂-C₂₀ alkenyl group, a C₂-C₂₀ alkynyl group, and a C₁-C₂₀ alkoxy group; and a C₁-C₂₀ alkyl group, a C₂-C₂₀ alkenyl group, a C₂-C₂₀ alkynyl group, and a C₁-C₂₀ alkoxy group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group.

In Formula 4, m1 may be an integer selected from 0 to 10.

* and *′ may each be a binding site to a neighboring atom.

In an exemplary embodiment, X₂ and X₃, Y₂ and Y₃, R₂, R₃, R₄, R₅, R₆, R₇, R₈, and R₉, and m1 are the same as defined in relation to Formula 2.

In an exemplary embodiment, the patterned body may include a polymer structure in which the unit of Formula 4 is included in a main chain of a polymer prepared by using the photocurable composition for pattern formation as both photocurable groups at two ends of the silicon-based monomer represented by Formula 2 participate in polymerization. Also, since the silicon-based monomer represented by Formula 2 has the photocurable groups at its two ends, this facilitates co-polymer formation with the fluorine-based monomer, and thus an improved releasability may be imparted to the patterned body manufactured by using the photocurable composition for pattern formation.

Also, in an exemplary embodiment, the patterned body may include a polymer structure in which the unit of Formula 3 is included in a side chain or at an end of a main chain of a polymer prepared by using the photocurable composition for pattern formation, as the fluorine-based monomer represented by Formula 1 only has a photocurable group at one end. Due to this structure, a co-polymer of the fluorine-based monomer and the silicon-based monomer may be formed, and thus a releasability may significantly improve, or a releasing force may significantly decrease, due to repulsion caused by the fluorine-based monomer and structural flexibility caused by the silicon-based monomer.

In an exemplary embodiment, a releasing force of the patterned body may be in a range of about 0.001 kgf to about 0.1 kgf, or, for example, about 0.03 kgf to about 0.05 kgf.

In an exemplary embodiment, a line width of the patterned body may be several tens of nm to several hundreds of nm. For example, a pattern line width (critical dimension, CD) may be in a range of about 0.01 nm to about 50 nm. In this regard, the patterned body may also form fine patterns having various dimensions and shapes while maintaining a high releasability.

Durability of the patterned body may be evaluated by counting how many times it is possible for releasing to occur without deformation of the pattern, and thus the durability of the patterned bodies may be relatively compared by evaluating changes in contact angles after releasing has occurred several times.

In an exemplary embodiment, a change in a water contact angle)(° before and after the releasing may be 5% or less. In another exemplary embodiment, a change in a water contact angle of the patterned body after 20 or more occurrences of releasing may be 10% or less, for example, 7% or less, or, for example, 5% or less, and thus the releasing may be possible without deformation of the pattern.

The term “C₁-C₆₀ alkyl group,” as used herein, refers to a linear or branched aliphatic hydrocarbon monovalent group having 1 to 60 carbon atoms, and examples thereof include a methyl group, an ethyl group, a propyl group, an isobutyl group, a sec-butyl group, a tert-butyl group, a pentyl group, an iso-amyl group, and a hexyl group. The term “C₁-C₆₀ alkylene group,” as used herein, refers to a divalent group having the same structure as the C₁-C₆₀ alkyl group.

The term “C₂-C₆₀ alkenyl group,” as used herein, refers to a hydrocarbon group formed by substituting at least one carbon-carbon double bond in the middle or at the terminal of the C₂-C₆₀ alkyl group, and examples thereof are an ethenyl group, a propenyl group, and a butenyl group. The term “C₂-C₆₀ alkenylene group,” as used herein, refers to a divalent group having the same structure as the C₂-C₆₀ alkenyl group.

The term “C₂-C₆₀ alkynyl group,” as used herein, refers to a hydrocarbon group formed by substituting at least one carbon-carbon triple bond in the middle or at the terminal of the C₂-C₆₀ alkyl group, and examples thereof are an ethynyl group and a propynyl group. The term “C₂-C₆₀ alkynylene group,” as used herein, refers to a divalent group having the same structure as the C₂-C₆₀ alkynyl group.

The term “C₁-C₆₀ alkoxy group,” as used herein, refers to a monovalent group represented by —OA₁₀₁ (wherein A₁₀₁ is the C₁-C₆₀ alkyl group), and examples thereof include a methoxy group, an ethoxy group, and an isopropyloxy group.

The term “C₃-C₁₀ cycloalkyl group,” as used herein, refers to a monovalent hydrocarbon monocyclic group having 3 to 10 carbon atoms, and non-limiting examples thereof include a cyclopropyl group, a cyclobutyl group, a cyclopentyl group, a cyclohexyl group, and a cycloheptyl group. The term “C₃-C₁₀ cycloalkylene group,” as used herein, refers to a divalent group having the same structure as the C₃-C₁₀ cycloalkyl group.

The term “C₁-C₁₀ heterocycloalkyl group,” as used herein, refers to a monovalent monocyclic group having at least one heteroatom selected from N, O, Si, P, and S as a ring-forming atom, and 1 to 10 carbon atoms, and examples thereof include a 1,2,3,4-oxatriazolidinyl group, a tetrahydrofuranyl group, and a tetrahydrothiophenyl group. The term “C₁-C₁₀ heterocycloalkylene group,” as used herein, refers to a divalent group having the same structure as the C₁-C₁₀ heterocycloalkyl group.

The term “C₃-C₁₀ cycloalkenyl group,” as used herein, refers to a monovalent monocyclic group that has 3 to 10 carbon atoms and at least one carbon- carbon-carbon double bond in the ring thereof and does not have aromaticity, and examples thereof include a cyclopentenyl group, a cyclohexenyl group, and a cycloheptenyl group. The term “C₃-C₁₀ cycloalkenylene group,” as used herein, refers to a divalent group having the same structure as the C₃-C₁₀ cycloalkenyl group.

The term “C₁-C₁₀ heterocycloalkenyl group,” as used herein, refers to a monovalent monocyclic group that has at least one heteroatom selected from N, O, Si, P, and S as a ring-forming atom, 1 to 10 carbon atoms, and at least one carbon-carbon double bond in its ring. Examples of the C₁-C₁₀ heterocycloalkenyl group include a 4,5-dihydro-1,2,3,4-oxatriazolyl group, a 2,3-dihydrofuranyl group, and a 2,3-dihydrothiophenyl group. The term “C₁-C₁₀ heterocycloalkenylene group,” as used herein, refers to a divalent group having the same structure as the C₁-C₁₀ heterocycloalkenyl group.

The term “C₆-C₆₀ aryl group,” as used herein, refers to a monovalent group having a carbocyclic aromatic system having 6 to 60 carbon atoms, and the term “C₆-C₆₀ arylene group,” as used herein, refers to a divalent group having a carbocyclic aromatic system having 6 to 60 carbon atoms. Examples of the C₆-C₆₀ aryl group include a phenyl group, a naphthyl group, an anthracenyl group, a phenanthrenyl group, a pyrenyl group, and a chrysenyl group. When the C₆-C₆₀ aryl group and the C₆-C₆₀ arylene group each include two or more rings, the rings may be fused to each other.

The term “C₁-C₆₀ heteroaryl group,” as used herein, refers to a monovalent group having a carbocyclic aromatic system that has at least one heteroatom selected from N, O, Si, P, and S as a ring-forming atom, and 1 to 60 carbon atoms. The term “C₁-C₆₀ heteroarylene group,” as used herein refers to a divalent group having a carbocyclic aromatic system that has at least one heteroatom selected from N, O, Si, P, and S as a ring-forming atom, and 1 to 60 carbon atoms. Examples of the C₁-C₆₀ heteroaryl group are a pyridinyl group, a pyrimidinyl group, a pyrazinyl group, a pyridazinyl group, a triazinyl group, a quinolinyl group, and an isoquinolinyl group. When the C₁-C₆₀ heteroaryl group and the C₁-C₆₀ heteroarylene group each include two or more rings, the rings may be fused to each other.

The term “C₅-C₆₀ carbocyclic group,” as used herein, refers to a monocyclic or polycyclic group including carbon only as a ring-forming atom and having 5 to 60 carbon atoms. The C₅-C₆₀ carbocyclic group may be an aromatic carbocyclic group or a non-aromatic carbocyclic group. The C₅-C₆₀ carbocyclic group may be a ring such as benzene, a monovalent group such as a phenyl group, or a divalent group such as a phenylene group. Also, depending on the number of substituents connected to the C₅-C₆₀ carbocyclic group, the C₅-C₆₀ carbocyclic group may be varied as a trivalent group or a tetravalent group.

The term “C₁-C₆₀ heterocyclic group,” as used herein, refers to a group having the same structure as the C₅-C₆₀ carbocyclic group and including at least one heteroatom selected from N, O, Si, P, and S as a ring-forming atom in addition to carbon (where the number of carbon atoms may be 1 to 60).

The term “C₁-C₂₀ hydrocarbon group,” as used herein, refers to a group including a carbon atom and a hydrogen atom, and examples of the C₁-C₂₀ hydrocarbon group may include a C₁-C₂₀ alkyl group, a C₁-C₂₀ alkenyl group, a C₁-C₂₀ alkynyl group, a C₃-C₁₀ cycloalkyl group, or a C₃-C₁₀ cycloalkenyl group.

Hereinafter, a compound and an organic light-emitting device according to one or more embodiments will be described in further detail with reference to Examples.

The expression “B was used instead of A” used in describing Examples may refer to a molar equivalent of A being identical to a molar equivalent of B.

### EXAMPLES

### Example 1

Example Composition 1 including 37.3 parts by weight of dipentaerythritol hexaacrylate (DPHA, available from Sartomer), 56.9 parts by weight of benzyl acrylate (M1182, available from Miwon Specialty), 1.9 parts by weight of Irgacure 184 (available from Ciba Specialty), 1.9 parts by weight of Irgacure 819 (available from Ciba Specialty), and 1.9 parts by weight of RS-56 (available from DIC Corporation) was prepared.

A patterned body according to an exemplary embodiment was prepared by using Example Composition 1.

### Comparative Example 1

A patterned body of Comparative Example 1 was prepared by using SR-14 (available from Minutatech) as Comparative Composition 1.

### Comparative Example 2

A patterned body of Comparative Example 2 was prepared in the same manner as in Example 1, except that Comparative Composition 2 including Miramer SIP 900 (available from Miwon Specialty) was used instead of 1.9 parts by weight of RS-56 (available from DIC Corporation) in Example 1.

### Comparative Example 3

A patterned body of Comparative Example 3 was prepared in the same manner as in Example 1, except that Comparative Composition 3 including TEGO Rad 2300 (available from Evonik Resource Efficienty GmbH) was used instead of 1.9 parts by weight of RS-56 (available from DIC Corporation).

### Evaluation Example 1: Releasability Evaluation

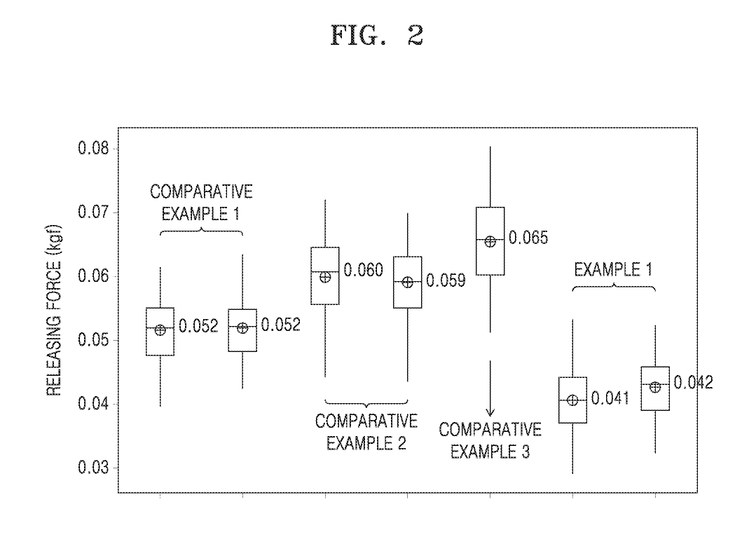

The results of measuring releasing forces of the patterned bodies prepared in Example 1 and Comparative Examples 1 to 3 are shown in FIG. 2.

When the releasing forces were measured, a patterned silicon wafer was used as a master to which the patterned body is released, and the patterned body was manufactured from the master. An imprinting resin was applied thereto, and the releasing forces of the releasing process were measured. The releasing forces were measured by using a tensil strength meter (Universal Test Machine: UTM).

Referring to FIG. 2, the patterned body of Example 1 has a low releasing force, that is, a releasability when released from a stamp is excellent compared to those of the patterned bodies of Comparative Examples 1 to 3, and thus it was confirmed that the patterned body of Example 1 may be re-used several times.

### Evaluation Example 2: Durability Evaluation

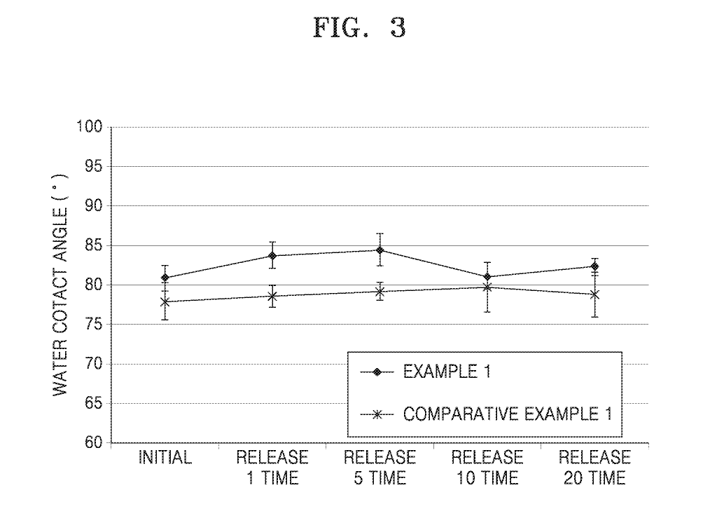

Durability of the patterned bodies prepared in Example 1 and Comparative Example 1 while releasing the imprinting resin were evaluated, and the results are shown in FIG. 3.

Referring to FIG. 3, the patterned body of Example 1 exhibited less change in a water contact angle before and after the release compared to that of the patterned body of Comparative Example 1, and the water contact angle did not change significantly even after 20 occurrences or more of releasing, and thus it may be confirmed that the patterned body of Example 1 has excellent durability.

As described above, according to one or more exemplary embodiments, a patterned body manufactured by using the photocurable composition for pattern formation may exhibit an excellent releasability and excellent durability while maintaining a high degree of pattern precision.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A photocurable composition for pattern formation, the photocurable composition comprising:
at least one multifunctional (meth)acrylate;
at least one monofunctional (meth)acrylate;
a release additive; and
a photoinitiator,
wherein the release additive comprises a fluorine-based monomer represented by Formula 1 and a silicon-based monomer represented by Formula 2: 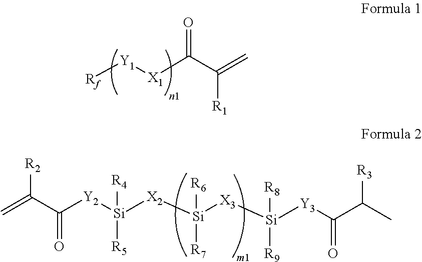
wherein, in Formulas 1 and 2,
X₁, X₂, and X₃ are each independently a single bond, —O—, or —S—,
Y₁, Y₂, and Y₃ are each independently selected from:
a single bond, —C(═O)—, —O—, a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group; and
a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, a C₁-C₂₀ alkoxy group, a C₃-C₁₀ cycloalkyl group, a C₃-C₁₀ cycloalkenyl group, a C₂-C₁₀ heterocycloalkyl group, a C₂-C₁₀ heterocycloalkenyl group, a C₆-C₂₀ aryl group, and a C₂-C₂₀ heteroaryl group,
R_{f} is a C₁-C₃₀ fluoroalkyl group,
R₁, R₂, R₃, R₄, R₅, R₆, R₇, R₈, and R₉ are each independently selected from hydrogen, deuterium, a C₁-C₂₀ alkyl group, a C₂-C₂₀ alkenyl group, a C₂-C₂₀ alkynyl group, and a C₁-C₂₀ alkoxy group; and
a C₁-C₂₀ alkyl group, a C₂-C₂₀ alkenyl group, a C₂-C₂₀ alkynyl group, and a C₁-C₂₀ alkoxy group, each substituted with at least one selected from a deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group,
n1 is an integer selected from 0 to 10, and
m1 is an integer selected from 0 to 10.

2. The photocurable composition of claim 1, wherein an amount of the at least one multifunctional (meth)acrylate is in a range of about 20 parts to about 50 parts by weight, an amount of the at least one monofunctional (meth)acrylate is in a range of about 40 parts to about 70 parts by weight, an amount of the release additive is in a range of about 0.1 parts to about 10 parts by weight, and an amount of the photoinitiator is in a range of about 0.1 parts to about 10 parts by weight.

3. The photocurable composition of claim 2, wherein an amount of the release additive is in a range of about 0.5 parts to about 5 parts by weight.

4. The photocurable composition of claim 1, wherein R_{f} is a C₁-C₃₀ perfluoroalkyl group.

5. The photocurable composition of claim 1, wherein the fluorine-based monomer represented by Formula 1 is represented by Formula 1-1: 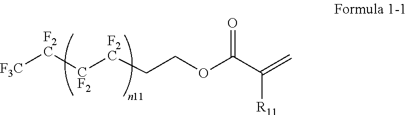
wherein, in Formula 1-1,
R₁₁ is selected from hydrogen, deuterium, a C₁-C₂₀ alkyl group, and a C₁-C₂₀ alkyl group substituted with at least one selected from deuterium, a C₁-C₂₀ alkyl group, and a C₁-C₂₀ alkoxy group; and
n11 is an integer selected from 0 to 10.

6. The photocurable composition of claim 1, wherein the silicon-based monomer represented by Formula 2 is represented by Formula 2-1: 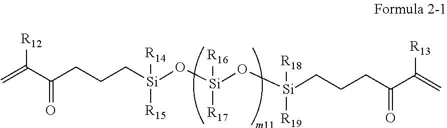
wherein, in Formula 2-1,
R₁₂, R₁₃, R₁₄, R₁₅, R₁₆, R₁₇, R₁₈, and R₁₉ are each independently selected from deuterium, a C₁-C₂₀ alkyl group, and a C₁-C₂₀ alkyl group substituted with at least one selected from deuterium, a C₁-C₂₀ alkyl group, and a C₁-C₂₀ alkoxy group, and
m11 is an integer selected from 0 to 10.

7. The photocurable composition of claim 1, wherein the release additive further comprises at least one difunctional (meth)acrylate.

8. The photocurable composition of claim 1, wherein the at least one multifunctional (meth)acrylate is selected from pentaerythritol tri(meth)acrylate, pentaerythritol tetra(meth)acrylate, pentaerythritol hexa(meth)acrylate, dipentaerythritol tri(meth)acrylate, dipentaerythritol penta(meth)acrylate, dipentaerythritol hexa(meth)acrylate, trimethylolpropane tri(meth)acrylate, tris(meth)acryloyloxyethyl phosphate, EO modified trimethylolpropane tri(meth)acrylate, EO-modified pentaerythritol tetra(meth)acrylate, and a combination thereof.

9. The photocurable composition of claim 1, wherein at least one example of the at least one multifunctional (meth)acrylate is a multifunctional (meth)acrylate comprising at least 4 functional groups.

10. The photocurable composition of claim 9, wherein the multifunctional (meth)acrylate comprising at least 4 functional groups is selected from pentaerythritol tetra(meth)acrylate, dipentaerythritol hexa(meth)acrylate, ditrimethylolpropane tetra(meth)acrylate, dipentaerythritol penta(meth)acrylate, and a combination thereof.

11. The photocurable composition of claim 1, wherein at least one example of the at least one multifunctional (meth)acrylate is EO-modified multifunctional (meth)acrylate.

12. The photocurable composition of claim 1, wherein the at least one multifunctional (meth)acrylate is selected from EO-modified trimethylolpropane tri(meth)acrylate, EO-modified pentaerythritol tetra(meth)acrylate, pentaerythritol tri(meth)acrylate, ditrimethylolpropane tetra(meth)acrylate, dipentaerythritol hexa(meth)acrylate, dipentaerythritol penta(meth)acrylate, and a combination thereof.

13. The photocurable composition of claim 1, wherein the at least one monofunctional (meth)acrylate is selected from methyl (meth)acrylate, ethyl (meth)acrylate, n-propyl (meth)acrylate, isopropyl (meth)acrylate, n-butyl (meth)acrylate, isoamyl (meth)acrylate, isobutyl (meth)acrylate, isooctyl (meth)acrylate, sec-butyl (meth)acrylate, t-butyl (meth)acrylate, n-pentyl (meth)acrylate, 3-methylbutyl (meth)acrylate, n-hexyl (meth)acrylate, 2-ethyl-n-hexyl (meth)acrylate, n-octyl (meth)acrylate, cyclohexyl (meth)acrylate, isobornyl (meth)acrylate, dicyclopentanyl (meth)acrylate, dicyclopentanyloxyethyl (meth)acrylate, isomyristyl (meth)acrylate, lauryl (meth)acrylate, methoxydipropyleneglycol (meth)acrylate, methoxytripropyleneglycol (meth)acrylate, benzyl (meth)acrylate, 2-hydroxyethyl (meth)acrylate, 2-hydroxypropyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 4-hydroxycyclohexyl (meth)acrylate, neopentylglycol mono(meth)acrylate, 3-chloro-2-hydroxypropyl (meth)acrylate, 1,1-dimethyl-3-oxobutyl (meth)acrylate, 2-acetoacetoxyethyl (meth)acrylate, 2-methoxyethyl (meth)acrylate, 2-ethoxyethyl (meth)acrylate, neopentylglycol mono(meth)acrylate, ethyleneglycol monomethylether (meth)acrylate, glycerin mono(meth)acrylate, 2-acryloyloxyethyl phthalate, 2-acryloyloxy 2-hydroxyethyl phthalate, 2-acryloyloxyethyl hexahydrophthalate, 2-acryloyloxy propylphthalate, neopentylglycolbenzoate (meth)acrylate, nonylpenoxypolyethyleneglycol (meth)acrylate, nonylpenoxypolypropyleneglycol (meth)acrylate, para-cumylphenoxyethyleneglycol (meth)acrylate, ECH modified phenoxy acrylate, phenoxyethyl (meth)acrylate, phenoxydiethyleneglycol (meth)acrylate, phenoxyhexaethyleneglycol (meth)acrylate, phenoxytetraethyleneglycol (meth)acrylate, polyethyleneglycol (meth)acrylate, polyethyleneglycol-polypropyleneglycol (meth)acrylate, polypropyleneglycol (meth)acrylate, stearyl (meth)acrylate, EO modified cresol (meth)acrylate, dipropyleneglycol (meth)acrylate, ethoxylated phenyl(meth)acrylate, EO modified succinic acid (meth)acrylate, tert-butyl (meth)acrylate, tribromophenyl (meth)acrylate, EO modified tribromophenyl (meth)acrylate, tridodecyl (meth)acrylate, and a combination thereof.

14. The photocurable composition of claim 1, wherein the at least one monofunctional (meth)acrylate comprises at least one structure selected from:
a C₅-C₆₀ carbocyclic group and a C₁-C₆₀ heterocyclic group; and
a C₅-C₆₀ carbocyclic group and a C₁-C₆₀ heterocyclic group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, a C₁-C₂₀ alkoxy group, a C₃-C₁₀ cycloalkyl group, a C₃-C₁₀ cycloalkenyl group, a C₂-C₁₀ heterocycloalkyl group, a C₂-C₁₀ heterocycloalkenyl group, a C₆-C₂₀ aryl group, and a C₂-C₂₀ heteroaryl group.

15. The photocurable composition of claim 1, wherein the photoinitiator is selected from a phenyl ketone-based compound, a phosphineoxide-based compound, and a combination thereof.

16. The photocurable composition of claim 1, wherein the photoinitiator comprises a phenyl ketone-based compound and a phosphineoxide-based compound, and a weight ratio of the phenyl ketone-based compound and the phosphineoxide-based compound is in a range of about 0.8:1 to about 1:0.8.

17. The photocurable composition of claim 1 further comprising an arylphosphine-based compound, wherein an amount of the arylphosphine-based compound is in a range of about 0.1 parts to about 10 parts by weight.

18. A patterned body manufactured by using the photocurable composition of claim 1.

19. The patterned body of claim 18 comprising a unit represented by Formula 3 and a unit represented by Formula 4: 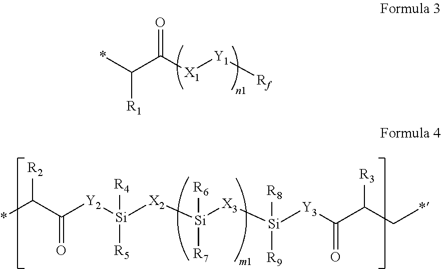
wherein, in Formula 3,
X₁ is a single bond, —O—, or —S—,
Y₁ is selected from:
a single bond, —C(═O)—, —O—, a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group; and
a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, a C₁-C₂₀ alkoxy group, a C₃-C₁₀ cycloalkyl group, a C₃-C₁₀ cycloalkenyl group, a C₂-C₁₀ heterocycloalkyl group, a C₂-C₁₀ heterocycloalkenyl group, a C₆-C₂₀ aryl group, and a C₂-C₂₀ heteroaryl group,
R_{f} is a C₁-C₃₀ fluoroalkyl group,
R₁ is selected from:
hydrogen, deuterium, a C₁-C₂₀ alkyl group, a C₂-C₂₀ alkenyl group, a C₂-C₂₀ alkynyl group, and a C₁-C₂₀ alkoxy group; and
a C₁-C₂₀ alkyl group, a C₂-C₂₀ alkenyl group, a C₂-C₂₀ alkynyl group, and a C₁-C₂₀ alkoxy group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group,
n1 is an integer selected from 0 to 10, and
* is a binding site to a neighboring atom; and
in Formula 4,
X₂ and X₃ are each independently a single bond, —O—, or —S—,
Y₂ and Y₃ are each independently selected from:
a single bond, —C(═O)—, —O—, a C₁-C₂₀ alkylene group, a C₃-C₁₀ cycloalkylene group, a C₃-C₁₀ cycloalkenylene group, C₂-C₁₀ heterocycloalkylene group, a C₂-C₁₀ heterocycloalkenylene group, a C₆-C₂₀ arylene group, and a C₂-C₂₀ heteroarylene group; and
a C₁-C₂₀ alkylene group, a C₃-C₁₀ cycloalkylene group, a C₃-C₁₀ cycloalkenylene group, a C₂-C₁₀ heterocycloalkylene group, a C₂-C₁₀ heterocycloalkenylene group, a C₆-C₂₀ arylene group, and a C₂-C₂₀ heteroarylene group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, a C₁-C₂₀ alkoxy group, a C₃-C₁₀ cycloalkyl group, a C₃-C₁₀ cycloalkenyl group, a C₂-C₁₀ heterocycloalkyl group, a C₂-C₁₀ heterocycloalkenyl group, a C₆-C₂₀ aryl group, and a C₂-C₂₀ heteroaryl group,
R₂, R₃, R₄, R₅, R₆, R₇, R₈, and R₉ are each independently selected from
hydrogen, deuterium, a C₁-C₂₀ alkyl group, a C₂-C₂₀ alkenyl group, a C₂-C₂₀ alkynyl group, and a C₁-C₂₀ alkoxy group; and
a C₁-C₂₀ alkyl group, a C₂-C₂₀ alkenyl group, a C₂-C₂₀ alkynyl group, and a C₁-C₂₀ alkoxy group, each substituted with at least one selected from deuterium, —F, —Cl, —Br, —I, a hydroxyl group, a cyano group, an epoxy group, a nitro group, an amidino group, a hydrazino group, a hydrazono group, a C₁-C₂₀ alkyl group, and a C₁-C₂₀ alkoxy group,
m1 is an integer selected from 0 to 10, and
* and *′ are each a binding site to a neighboring atom.

20. The patterned body of claim 18, wherein a pattern line width (CD) is in a range of about 0.01 nm to about 50 nm.
